(19) United States
(12) Patent Application Publication
(10) Pub. No.: US 2022/0349239 A1
(43) Pub. Date: Nov. 3, 2022

(54) SPRING-ASSISTED ROTARY ACTUATOR

(71) Applicant: Allied Motion Technologies Inc., Amherst, NY (US)

(72) Inventors: William A. HELLINGER, Mexico, NY (US); Jeffrey M. SHEARER, North Tonawanda, NY (US); Tyler J. LISEC, Watertown, NY (US)

(21) Appl. No.: 17/765,993

(22) PCT Filed: Oct. 1, 2020
(86) PCT No.: PCT/US20/53869

§ 371 Date: Apr. 1, 2022

Related U.S. Application Data
(60) Provisional application No. 62/909,178, filed on Oct. 1, 2019.

(51) Int. Cl. E05F 15/692

(52) U.S. Cl. CPC E05F 15/692; E05Y 2900/55; E05Y 2201/244; E05Y 2201/416

(57) ABSTRACT

The present disclosure may be embodied as a rotary actuator for lifting a load against gravity. The actuator includes a housing and a drive motor attached to the housing. The drive motor has a drive shaft. The drive shaft may be configured to be manually operated. A rotatable output shaft is attached to the housing and in mechanical communication with drive shaft. The actuator includes at least one spring which is configured to act on the output shaft to at least partially offset a weight of the load. The at least one spring may be a torsion spring. The at least one spring may be configured to unwind when the motor is driven to lift the load, and may be configured to be wound when the motor is driven to lower the load. The at least one spring may comprise a plurality of springs, such as torsion springs.

### FIELD OF THE DISCLOSURE

The present disclosure relates to actuators, and more particularly to rotary actuators.

### BACKGROUND OF THE DISCLOSURE

Rotary actuators are often used to displace loads. For example, a rotary actuator may be used to move load by way of a rack gear assembly, a pulley, etc. In some applications, the load may be displaced against gravity, in which case the rotary actuator must be sized so as to be appropriate for the weight of the load. For example, the rotary actuator may be used to raise and lower a power window in a vehicle. In some application, the load may weigh a great deal (e.g., a large window, thick pane of glass, etc.) Often, this results in a large drive motor and/or a high reduction gear train. Such designs result in actuators which may be bulky, heavy, slow, expensive, and/or have high power requirements. There is a long-felt need for a more efficient actuator design.

### BRIEF SUMMARY OF THE DISCLOSURE

The present disclosure may be embodied as a rotary actuator for lifting a load against gravity. The actuator includes a housing and a drive motor attached to the housing. The drive motor may be a brushless DC motor. The drive motor has a drive shaft. The driveshaft may be configured to be manually operated. A rotatable output shaft is attached to the housing and in mechanical communication with drive shaft. The actuator includes at least one spring which is configured to act on the output shaft to at least partially offset a weight of the load. The at least one spring may be a torsion spring. The at least one spring may be configured to unwind when the motor is driven to lift the load. The at least one spring may be configured to be wound when the motor is driven to lower the load. The at least one spring may comprise a plurality of springs, such as torsion springs. Each spring of the plurality of springs may be configured to act on the output shaft. A pulley may be attached to the output shaft.

The rotary actuator may include a brake configured to prevent motion of the output shaft. The brake may act on the drive shaft of the motor. The brake may include a brake lever configured to selectively engage/disengage the brake.

The rotary actuator may include a gear train having an input gear configured to be rotated by the drive shaft and an output gear configured to rotate the output shaft. For example, the rotary actuator may be a speed reduction gear train. The gear train may include a manual input shaft for manual operation. The gear train may include a clutch operable to disengage at least a portion of the gear train from the drive shaft.

### DESCRIPTION OF THE DRAWINGS

For a fuller understanding of the nature and objects of the disclosure, reference should be made to the following detailed description taken in conjunction with the accompanying drawings, in which:

FIG. 1A is a perspective view of an actuator according to an embodiments of the present disclosure;

FIG. 1B is a perspective view of the actuator of FIG. 1A, viewed from another angle;

FIG. 2 is a top view of the actuator of FIGS. 1A and 1B with a portion of the housing removed for show hidden components; and

FIG. 3 is a perspective view of the actuator of FIGS. 1A, 1B, and 2 with portions of the actuator removed to show otherwise hidden components.

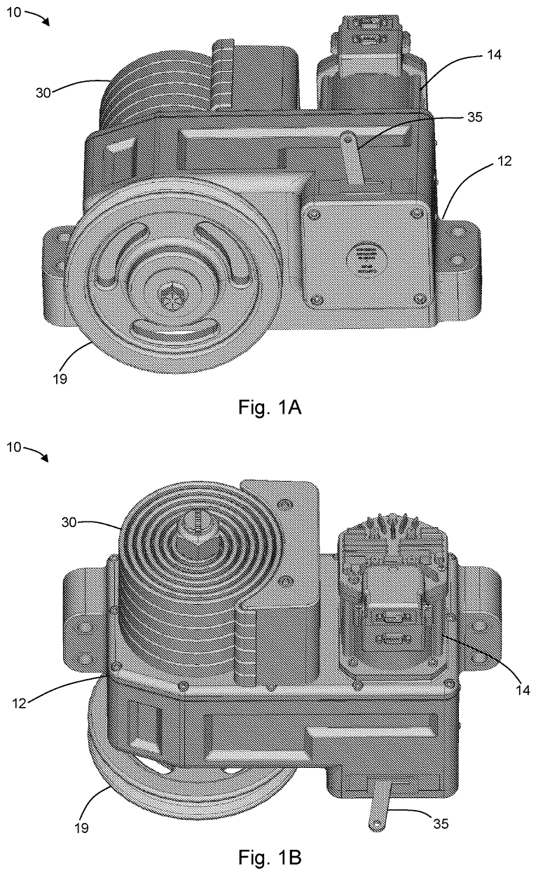

### DETAILED DESCRIPTION OF THE DISCLOSURE

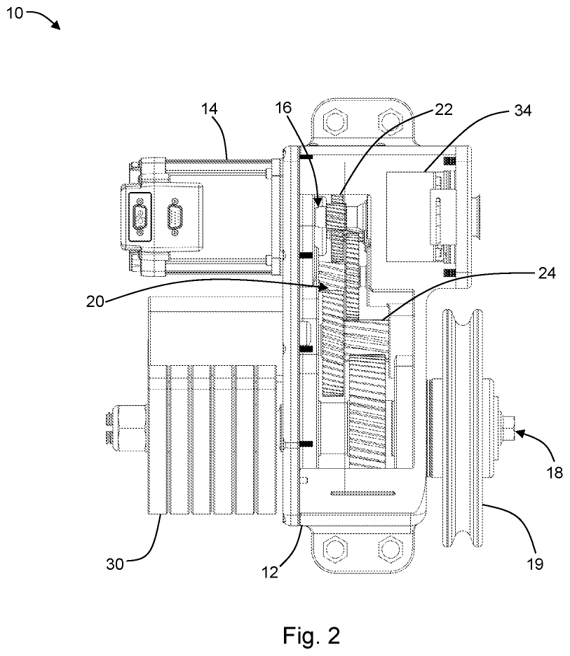

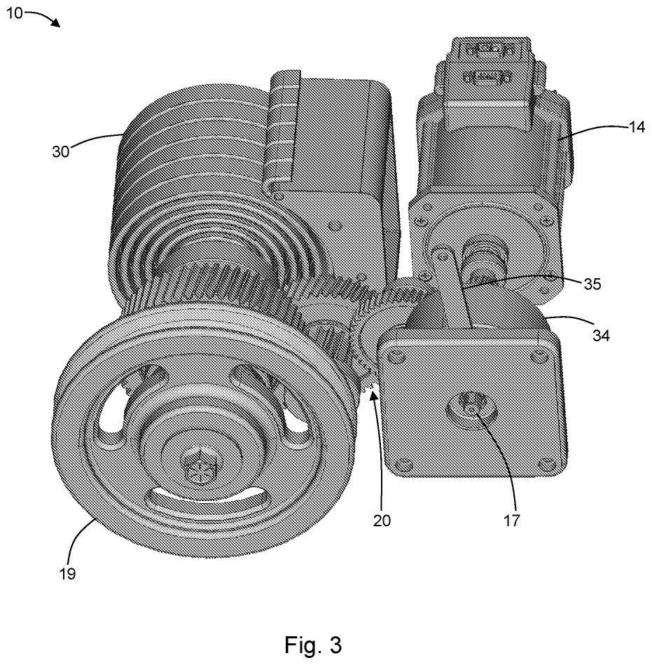

The present disclosure may be embodied as a rotary actuator 10 for lifting a load against gravity. The rotary actuator 10 has a housing 12 with a drive motor 14 attached to the housing 12. The drive motor 14 may be, for example, a brushless direct current (DC) motor, though other motors may be used. The drive motor 14 has a drive shaft 16 (see FIGS. 2 and 3). It should be noted that components may be attached to the housing 12 directly or indirectly. For example, the drive motor 14 may be attached (for example, bolted) directly to the housing. In another example, the motor may be mounted to a bracket and the bracket bolted, welded, or otherwise joined to the housing. Other attachment configurations may be used as will be apparent in light of the present disclosure. In another example, rotating components (e.g., gears, shafts, etc.) may be attached to the housing by way of, for example, bearings, bushings, and/or other structures (bosses, fasteners, clamps, brackets, etc.) The housing may contain one or more components of the actuator (such as, for example, the drive motor). However, in some embodiments, the housing may not contain other components, or may only partially contain other components. For example, in some embodiments, the housing is a bracket to which other components may be attached but does not contain such other components.

The rotary actuator 10 includes a rotatable output shaft 18 attached to the housing 12. The rotary output shaft 18 is in mechanical communication with the drive shaft 16. For example, the output shaft 18 may have a gear mounted thereon which is meshed with a gear of the drive shaft 16. The output shaft 18 may be in mechanical communication with the drive shaft 16 by way of a gear train 20. In this way, the gear train 20 may provide a mechanical advantage to either the output shaft or the drive shaft. In the present application of lifting a load against gravity, the gear train 20 may be configured as a speed reduction gear train (such that a rotational speed of the output shaft is less than a rotational speed of the drive shaft). In this way, the drive motor 14 is provided with a mechanical advantage such that torque produced by the motor is increase at the output shaft 18.

The gear train 20 includes an input gear 22 configured to be rotated by the drive shaft 16 (e.g., a gear on the drive shaft), and the gear train 20 includes an output gear 24 configured to rotate the output shaft 18 (e.g., a gear on the output shaft). The gear train may include a clutch operable to disengage at least a portion of the gear train from the output shaft and/or the output shaft.

The rotary actuator 10 includes at least one spring 30 configured to act on the output shaft 18. The at least one spring 30 is configured to at least partially offset a weight of a load on the output shaft 18. In an exemplary embodiment, a load to be raised or lowered has a weight which must be moved against gravity (when the load is being raised) or moved with gravity (when the load is lowered). An embodiment of the present spring-assisted rotary actuator may include a number of springs, each configured to offset some (or all) of the weight of the load. In this way, a drive motor with a lower rating (less lifting power) may be used. The at least one spring 30 may be a torsion spring configured to unwind when the load is moved against gravity, thereby providing an amount of lifting force to assist the drive motor. The at least one spring may also be configured to be wound as the load is lowered by the drive motor. In some embodiments, such as the motor depicted in the figures, the at least one spring may include a plurality of springs, such as, for example, a plurality of torsion springs.

In some embodiments, the drive shaft 16 is configured to be manually operated. For example, the drive shaft 16 may include a coupler 17 for attachment of a manually-operated tool. By manually operated, it should be noted that any form of external operation (i.e., other than the drive motor of the actuator) may be used for manual operation. For example, manual operation may include attaching a hand crank to the coupler 17 for cranking the output shaft by hand. In another example, a drive tool (e.g., a cordless drill, driver, etc.) may be attached to the coupler and the output shaft may be driven using the drive tool. In some embodiments, the gear train may include a manual input shaft for manual operation.

Some embodiments of the presently-disclosed actuator 10 include a brake 34 configured to prevent motion of the output shaft 18. For example, a brake 34 may act on the drive shaft 16 of the drive motor 14 to prevent motion of the output shaft 18. Other configurations may provide a brake acting on the output shaft or a brake acting on one or more components of a gear train. An actuator may include combinations of more than one such brake. The brake 34 may include a brake lever 35 for engaging/disengaging the brake.

The actuator 10 may include a pulley 19 attached to the output shaft 18. The pulley 19 may be configured to move the load by way of, for example, a belt or chain. In other embodiments, the output shaft includes a gear to move the load by way of, for example, a rack gear. Other embodiments will be apparent to one having skill in the art in light of the present disclosure.

Although the present disclosure has been described with respect to one or more particular embodiments, it will be understood that other embodiments of the present disclosure may be made without departing from the spirit and scope of the present disclosure.

We claim:

1. A rotary actuator for lifting a load against gravity, comprising:
a housing;
a drive motor attached to the housing, the drive motor having a drive shaft;
a rotatable output shaft attached to the housing and in mechanical communication with the drive shaft;
at least one spring configured to act on the output shaft to at least partially offset a weight of the load.

2. The rotary actuator of claim 1, wherein the drive shaft is configured to be manually operated.

3. The rotary actuator of claim 1, wherein the at least one spring is a torsion spring configured to unwind when the motor is driven to lift the load.

4. The rotary actuator of claim 3, wherein the at least one spring is further configured to be wound when the motor is driven to lower the load.

5. The rotary actuator of claim 1, wherein the at least one spring comprises a plurality of torsion springs, and wherein each spring of the plurality of torsion springs is configured to act on the output shaft.

6. The rotary actuator of claim 1, further comprising a brake configured to prevent motion of the output shaft.

7. The rotary actuator of claim 6, wherein the brake acts on the drive shaft of the motor.

8. The rotary actuator of claim 6, wherein the brake includes a brake lever configured to selectively engage/disengage the brake.

9. The rotary actuator of claim 1, further comprising a gear train having an input gear configured to be rotated by the drive shaft and an output gear configured to rotate the output shaft.

10. The rotary actuator of claim 9, wherein the gear train is a speed reduction gear train.

11. The rotary actuator of claim 9, wherein the gear train includes a manual input shaft for manual operation.

12. The rotary actuator of claim 9, wherein the gear train includes a clutch operable to disengage at least a portion of the gear train from the drive shaft.

13. The rotary actuator of claim 1, wherein the drive motor is a brushless DC motor.

14. The rotary actuator of claim 1, further comprising a pulley attached to the output shaft.
